(19) United States
(12) Patent Application Publication
(10) Pub. No.: US 2019/0018885 A1
(43) Pub. Date: Jan. 17, 2019

(54) INDEX AWARE TYPEAHEAD IN SEARCHES

(71) Applicant: LinkedIn Corporation, Sunnyvale, CA (US)

(72) Inventors: Swanand Wakankar, Campbell, CA (US); Dhruv Arya, Sunnyvale, CA (US); Saurabh Kataria, Newark, CA (US)

(21) Appl. No.: 15/648,237

(22) Filed: Jul. 12, 2017

(51) Int. Cl. G06F 17/30

(52) U.S. Cl. CPC G06F 17/30554; G06Q 50/01; G06F 17/3097

(57) ABSTRACT

Method and system to generate index aware typeahead suggestions is provided. The system is configured to generate one or more typeahead suggestions that are index aware, by taking into account the number of valid search results that match a query that corresponds to a typeahead suggestion. The system detects an input string in the search box, generates a candidate typeahead suggestion string, interrogates an index of the electronic publications with the candidate typeahead suggestion string to generate a recall value that represents a number of electronic publications that include the candidate typeahead suggestion string, and includes the candidate typeahead suggestion string in a list of typeahead suggestions based on the recall value. The list of typeahead suggestions is communicated to a client system.

### TECHNICAL FIELD

This application relates to the technical fields of software and/or hardware technology and, in one example embodiment, to system and method to generate index aware typeahead suggestions.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. A member profile in an on-line social network system may also represent a group, a company, a school, etc. Member profiles in an on-line social network system may be referred to as simply profiles.

An on-line social network system may include a search system that permits members to search information, such as, e.g., jobs postings, people, etc., within an on-line social network. The searches within the on-line social network may be viewed as navigational (where the intent of the search—search intent—is to locate a specific item, e.g., a particular person) or exploratory (where the intent of the search is to scan through the available information in order to identify potentially interesting or useful items). A navigational search may be fairly specific (e.g., indicating the first and last name of a person). An exploratory search, on the other hand, may return a great number of search results, which may sometimes make it difficult to identify those search results that are most useful. A search system may process a search request by matching a search string against the stored content to determine, which documents or records contain the search string. The documents that contain the search string, or references to those documents, are returned as search results. A search system may obtain a search string, e.g., by accessing input provided by a user via a search box presented as part of Graphical User Interface (GUI).

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate index aware typeahead suggestions may be implemented;

FIG. 2 is block diagram of a system to generate index aware typeahead suggestions, in accordance with one example embodiment;

FIG. 3 is a flow chart of a method to generate index aware typeahead suggestions, in accordance with an example embodiment;

FIG. 4 is an example User Interface screen illustrating presentation of index aware typeahead suggestions, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to generate index aware typeahead suggestions in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, provide recommendations and endorsements for each other and otherwise be in touch via the social network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc.).

The profile of a member may also include information about the member's current and past employment, such as company identifications, professional titles held by the associated member at the respective companies, as well as the member's dates of employment at those companies. A professional title that may be present in a member profile and indicate a professional position of the member during a particular period of employment may be referred to as a title string. Thus, a title string that appears in a member profile may be associated with a particular company and also with a period of time during which the member held, at that company, a particular position.

The on-line social network system also maintains information about various companies, as well as so-called job postings. A job posting, also referred to as merely “job” for the purposes of this description, is an electronically stored publication that includes information that an employer may post with respect to a job opening. The information in a job posting may include information associated with distinct predefined categories, such as, e.g., industry, company, job position, required and/or desirable skills, geographic location of the job, etc. These predefined categories are referred to as entity types, for the purposes of this description. For example, the strings describing professional skills of a user, such as, e.g., “patent drafting,” “window cleaning,” or “Java,” are designated as entities of type “Skill.” Strings that identify professional titles of users, such as, e.g., “software engineer” or “patent attorney,” are designated as entities of type “Title.” Strings that identify organizations that provide employment, such as, e.g., “Apple” or “Google,” are designated as entities of type “Company.”

An on-line social network system may include a search system that permits users to search for a wide range of information, such as, e.g., jobs, people, companies, etc. Users may be able to access information via a respective search directory web page that displays a keyword-based alphabetical index. Users may also access information by entering one or more keywords into the search box, engaging a control responsible for initiating a search, and examining the returned search results. As a user begins to type characters into a search box, the search system generates suggestions of how the partially entered string may be completed to form a query. For example, when a user types a sequence “le” in the search box, the search system treats the sequence “le” as prefix information and may present an option to complete the input string to read “legal,” since “legal is a keyword that starts with the sequence “le.” Suggestions for potential queries may be generated based semantic closeness of the prefix with the queries from a previously stored collection of potential queries, where the candidate suggestions that have been selected based on the prefix are examined to determine a suggestion that represents the most popular query (e.g., the one that was most frequently requested during a predetermined period of time), determine whether that suggestion is associated with a particular entity type (e.g., whether the string representing the suggestion is mapped to an entry in one of the standardized entities dictionary), and, if so, tag this typeahead suggestion with that entity type and present it as a selectable user interface (UI) element in the search UI that is presented on the display device of a user. This typeahead suggestion corresponds to a query that is associated with the particular entity type. If the user selects the typeahead suggestion and requests a search based on that typeahead suggestion, the search system is able to determine whether that particular entity type is associated with one or more specific fields in the collection of electronic documents and, if so, search only those specific fields in the documents from the collection.

One or more components of the search system that are engaged in processing input typed into a search box and generating suggested queries for user's selection are termed, collectively a smart typeahead system. The smart typeahead system is configured to generate query suggestions that are constructed to produce results characterized by increased relevancy and recall.

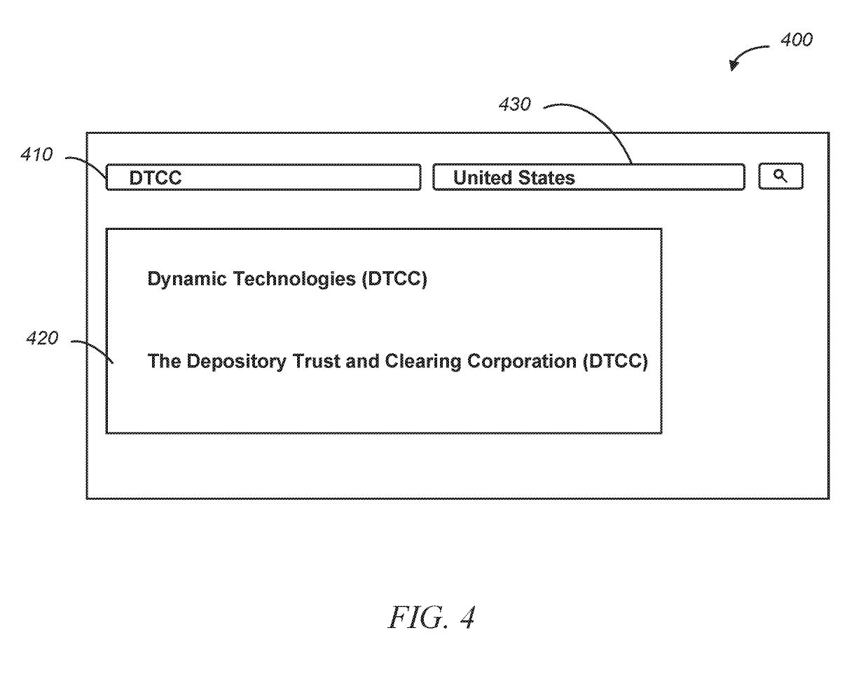

In one embodiment, the smart typeahead system is capable of generating a typeahead suggestion that is index aware, as it takes into account the number of valid search results that match a query that corresponds to a typeahead suggestion. For example, if a user, in addition to entering a string into the search box, selects a location filter (indicates, via the search UI, that the search results are to be limited to those associated with the specified geographic location, such as, e.g., San Francisco Bay Area”), as location, then the smart typeahead system provides to the user only those typeahead suggestions that would produce at least some search results if selected to be submitted to the search system as the search query. For example, as shown on screen 400 in FIG. 4, when a user types a sequence “DTCC” in the search box 410, the smart typeahead system determines that the typeahead suggestions should be of entity type “Company” and presents, in area 420, a drop down list that includes selectable typeahead suggestions “Dynamic Technologies (DTCC)” and “The Depository Trust and Clearing Corporation (DTCC),” but not “DTCC.EU,” if the user also requested the geographic location to be limited to the United States, as shown in area 430.

In the embodiment where the smart typeahead system is utilized in the context of a job search facilitated by the online social network system, the number of valid search results that match a query that corresponds to a typeahead suggestion may be determined using facet counting or, alternatively, using Voldemort. Facet counting entails accessing the Jobs index directly at runtime to determine almost-real-time jobs count for a particular facet. A facet corresponds to a query criteria and can be associated with an entity type such as company, skill or title. Voldemort storage is key-value store. The search system can precompute the number of jobs posted by a company for a skill for a particular title (or, e.g., for just a particular skill or for just a particular title) at a certain point in time and store it in that key-value store.

As the smart typeahead system may produce multiple typeahead suggestions, the candidate typeahead suggestions are ranked based on popularity of the associated queries. For example, a query represented by the string “Journalist or Disk Jockey” is unlikely to be more popular than a query represented by the string “Java Engineer.” The candidate typeahead suggestions are also ranked based on ranked the number of valid search results that match a query that corresponds to respective candidate typeahead suggestion.

In some embodiments, the smart typeahead system may utilize a personalized ranking model as a ranking function for typeahead suggestions. A personalized ranking model may be trained using typeahead candidate features, such term frequency-inverse document frequency (tf-idf) for typeahead candidate query logs and CTR for every typeahead candidate. A personalized ranking model can also be trained using entity aware features, such as respective CTRs for typeahead suggestions associated with different entity types, as well as personalized features, such as previous search history based on the user logs, inter industry searches for the industry of the user, intra industry searches for the industry of the user, etc. A personalized ranking model may be configured to take into account short term as well as long term query history.

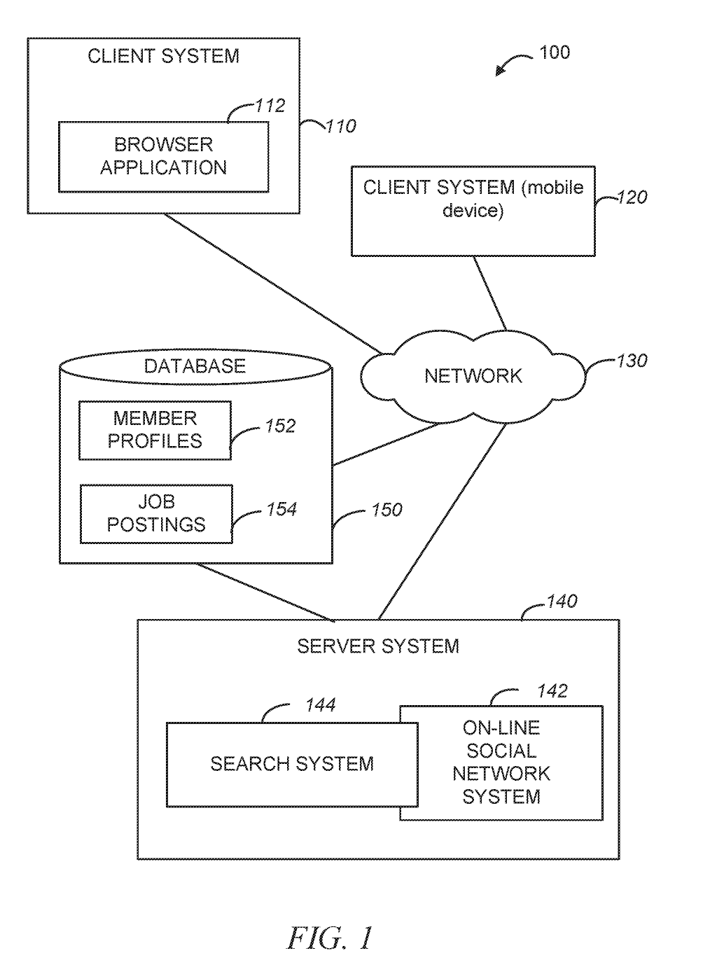

The smart typeahead system may be configured to include or to communicate with a performance evaluator, which can use multiple metrics to measure performance of the smart typeahead system. The performance evaluator can measure how the number of characters in the input string affects the relevance of typeahead suggestions. As the performance evaluator reports improvement with respect to the performance of a particular typeahead suggestion, e.g., based on an increase of user selection of that typeahead suggestion, the smart typeahead system may be adjusted to display that typeahead suggestion in response to a shorter input string, and also to display that suggestion closer to the top in the list of typeahead suggestions. The performance evaluator may be configured to calculate a click through rate (CTR) metric for a particular typeahead suggestion as the number of times a user selects a typeahead suggestion divided by the number of times the typeahead suggestion are shown. The performance evaluator can also be configured to measure recall for job search queries selected from typeahead suggestions, as well as the number of times a “No Jobs Found” page is loaded after selecting a typeahead suggestion. Example method and system to generate index aware typeahead suggestions may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152. The database 150 also stores job postings 154, as well as standardized dictionaries, and query logs.

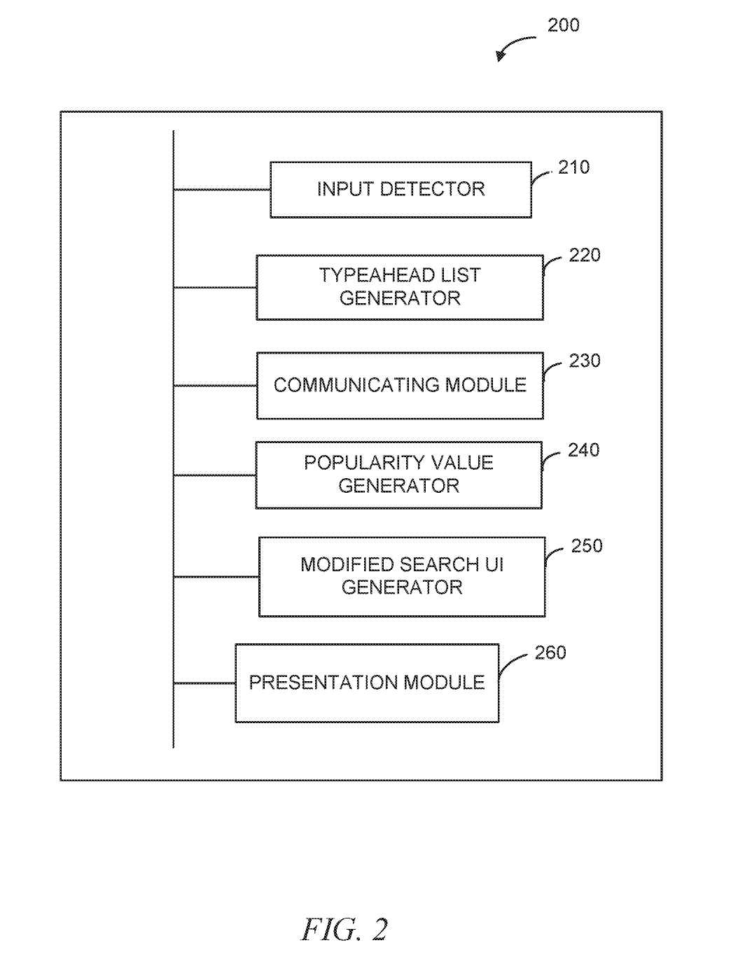

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a search system 144 that may be utilized beneficially to aid users in formulating a search request. The search system 144 includes an index aware smart typeahead system configured to generate typeahead suggestions using the methodologies described herein. An example search system 144 is illustrated in FIG. 2.

FIG. 2 is a block diagram of a system 200 to generate index aware typeahead suggestions, in accordance with one example embodiment. As shown in FIG. 2, the system 200 includes an input detector 210, a typeahead list generator 220, a communicating module 230, a popularity value generator 240, a modified search UI generator 250, and a presentation module 260.

The input detector 210 is configured to detect an input string in a search box presented on a display device of a client system as part of a search user interface (UI) of a computing application, such as, e.g., the input box 410 shown in FIG. 4. The computing application, in one embodiment, is the online social network system that maintains a plurality of job postings and a plurality of member profiles. A job posting from the plurality of job postings includes information of the first entity type (e.g., of entity type “Skill”) and information of the second entity type (e.g., of entity type “Title”).

The typeahead list generator 220 is configured to generate a candidate typeahead suggestion string based on the input string, interrogate an index of the electronic publications with the candidate typeahead suggestion string to generate a recall value that represents a number of electronic publications that include the candidate typeahead suggestion string in a list of typeahead suggestions, and determines whether to include or omit the candidate typeahead suggestion string in the list of typeahead suggestions based on the recall value. The determination of whether to include a candidate typeahead suggestion string in a list of typeahead suggestions may be further based on a popularity value, which is generated by the popularity value generator 240. The popularity value represents a number of previously processed searches associated with the candidate typeahead suggestion string. The communicating module 230 is configured to communicate the list of typeahead suggestions to the client system.

The input detector 210 is also configured to detect activation of a filter selection control included in the search UI. Whenever a filter control is activated, the typeahead list generator 220 generates a candidate typeahead suggestion string based on filter criteria indicated by the filter selection control in addition to the input string. The filter criteria may be, e.g., a geographic location, as illustrated in FIG. 4.

The items included in the list of typeahead suggestions may be ranked by a ranker (not shown). Where the detecting of the input string is associated with a member profile maintained by the online social network system, the ranker may be configured to rank items in the list of typeahead suggestions based on information regarding previously requested searches for the member profile. In some embodiments, the candidate typeahead suggestion string is from a plurality of items, the system comprising a ranker to rank items in the plurality of items based on information regarding previously requested searches for the member profile.

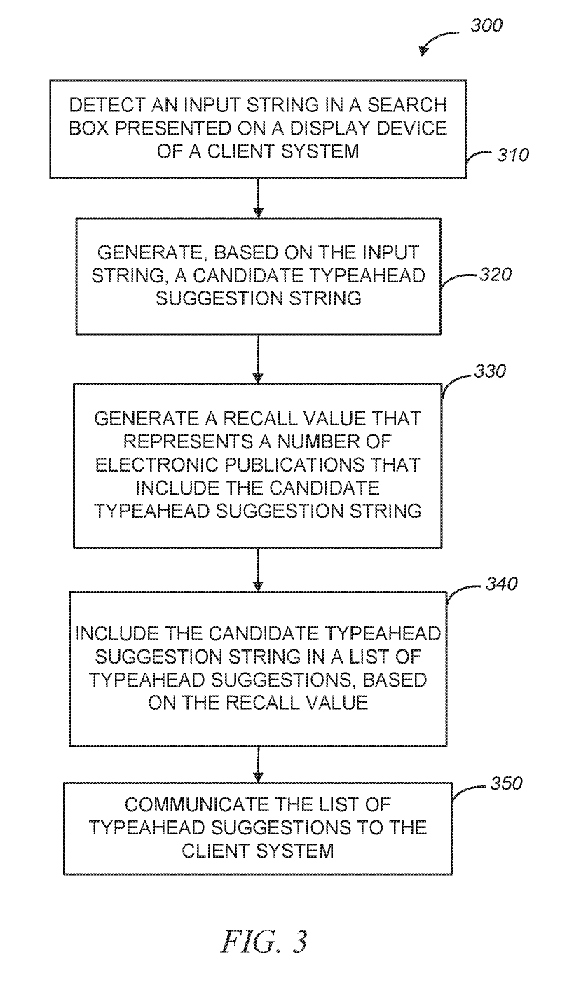

The modified search UI generator 250 is configured to generate a modified search UI by including a query selection control represented by a typeahead suggestion string from the list of typeahead suggestions in the search UI. The presentation module 260 is configured to cause presentation of the modified search UI on a display device. The search UI generator is also configured to include a typeahead suggestion string from the list of typeahead suggestions into the search box in response to detecting activation of the query selection control represented by that typeahead suggestion string. Some operations performed by the system 200 may be described with reference to FIG. 3.

FIG. 3 is a flow chart of a method 300 to generate multiple entity aware typeahead suggestions, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the input detector 210 of FIG. 2 detects an input string in a search box presented on a display device of a client system as part of a search user interface (UI) of a computing application, such as, e.g., the input box 410 shown in FIG. 4.

The typeahead list generator 220 generates a candidate typeahead suggestion string based on the input string at operation 320, interrogates at operation 320 an index of the electronic publications with the candidate typeahead suggestion string to generate a recall value that represents a number of electronic publications that include the candidate typeahead suggestion string, and selectively includes the candidate typeahead suggestion string in a list of typeahead suggestions based on the recall value at ioeration 340. As explained above, the determination of whether to include a candidate typeahead suggestion string in a list of typeahead suggestions may be further based on a popularity value, which represents a number of previously processed searches associated with the candidate typeahead suggestion string. The communicating module 230 to communicates the list of typeahead suggestions to the client system at operation 350.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

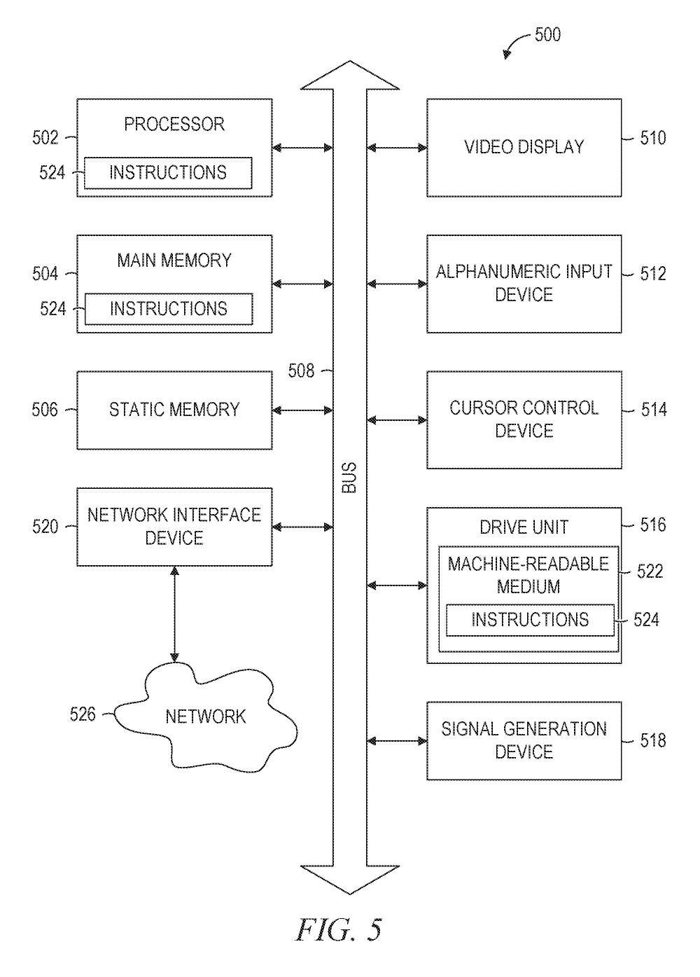

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to generate index aware typeahead suggestions have been described. While the techniques for formulating a search query have been described with reference to searches in the context of an on-line social network system, the method and system to generate index aware typeahead suggestions may be used beneficially in any context where electronic search results are being requested and retrieved. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
generating a search user interface (UI) for retrieving electronic publications provided with a computing application, the search UI including a search box;
detecting an input string in the search box;
using at least one processor, generating, based on the input string, a candidate typeahead suggestion string;
interrogating an index of the electronic publications with the candidate typeahead suggestion string to generate a recall value that represents a number of electronic publications that include the candidate typeahead suggestion string;
including the candidate typeahead suggestion string in a list of typeahead suggestions, based on the recall value; and
communicating the list of typeahead suggestions to the client system.

2. The method of claim 1, comprising determining a popularity value that represents a number of previously processed searches associated with the candidate typeahead suggestion string, the including of the candidate typeahead suggestion string in a list of typeahead suggestions is further based on the popularity value.

3. The method of claim 1, comprising:
generating, based on the input string, a further candidate typeahead suggestion string;
interrogating the index of electronic publications with the further candidate typeahead suggestion string and the filter criteria to generate a further recall value that represents a number of electronic publications that include the further candidate typeahead suggestion string;
omitting the further candidate typeahead suggestion string from the list of typeahead suggestions, based on the further recall value.

4. The method of claim 1, comprising detecting activation of a filter selection control included in the search UI, wherein the generating of the candidate typeahead suggestion string is further based on filter criteria indicated by the filter selection control.

5. The method of claim 1, wherein the detecting of the input string is associated with a member profile maintained by the computing application.

6. The method of claim 5, wherein the candidate typeahead suggestion string is from a plurality of items, the method comprising ranking items in the plurality of items based on information regarding previously requested searches for the member profile.

7. The method of claim 1, wherein the communicating the list of typeahead suggestions to the client system comprises:
generating a modified search UI by including a query selection control represented by a typeahead suggestion string from the list of typeahead suggestions in the search UI; and
causing presentation of the modified search UI on a display device.

8. The method of claim 1, wherein the electronic publications are job postings made available for retrieval by the computing application.

9. The method of claim 1, wherein the filter criteria is a geographic location.

10. The method of claim 1, wherein the computing application is an on-line social network system.

11. A computer-implemented system comprising:
an input detector, implemented using at least one processor, to detect an input string in a search box provided as part of a search user interface (UI) for retrieving electronic publications provided with a computing application;
a typeahead list generator, implemented using at least one processor, to:
generate, based on the input string, a candidate typeahead suggestion string,
interrogate an index of the electronic publications with the candidate typeahead suggestion string to generate a recall value that represents a number of electronic publications that include the candidate typeahead suggestion string, and
include the candidate typeahead suggestion string in a list of typeahead suggestions, based on the recall value; and
a communicating module to communicate the list of typeahead suggestions to the client system.

12. The system of claim 11, comprising a popularity value generator to determine a popularity value that represents a number of previously processed searches associated with the candidate typeahead suggestion string, the including of the candidate typeahead suggestion string in a list of typeahead suggestions is further based on the popularity value.

13. The system of claim 11, wherein the typeahead list generator is to:
generate, based on the input string, a further candidate typeahead suggestion string;
interrogate the index of electronic publications with the further candidate typeahead suggestion string and the filter criteria to generate a further recall value that represents a number of electronic publications that include the further candidate typeahead suggestion string; and
omit the further candidate typeahead suggestion string from the list of typeahead suggestions, based on the further recall value.

14. The system of claim 11, wherein the input detector is to detect activation of a filter selection control included in the search UI, wherein the generating of the candidate typeahead suggestion string is further based on filter criteria indicated by the filter selection control.

15. The system of claim 11, wherein the detecting of the input string is associated with a member profile maintained by the computing application.

16. The system of claim 15, wherein the candidate typeahead suggestion string is from a plurality of items, the system comprising a ranker to rank items in the plurality of items based on information regarding previously requested searches for the member profile.

17. The system of claim 11, comprising:
a modified search UI generator, implemented using at least one processor, to generate a modified search UI by including a query selection control represented by by including a query selection control represented by a typeahead suggestion string from the list of typeahead suggestions in the search UI; and
a presentation module, implemented using at least one processor, to cause presentation of the modified search UI on a display device.

18. The system of claim 11, wherein the electronic publications are job postings made available for retrieval by the computing application.

19. The system of claim 11, wherein the filter criteria is a geographic location.

20. A machine-readable non-transitory storage medium having instruction data executable by a machine to cause the machine to perform operations comprising:
generating a search user interface (UI) for retrieving electronic publications provided with a computing application, the search UI including a search box;
detecting an input string in the search box;
using at least one processor, generating, based on the input string, a candidate typeahead suggestion string;
interrogating an index of the electronic publications with the candidate typeahead suggestion string to generate a recall value that represents a number of electronic publications that include the candidate typeahead suggestion string;
including the candidate typeahead suggestion string in a list of typeahead suggestions, based on the recall value; and
communicating the list of typeahead suggestions to the client system.
